(19) United States
(12) Patent Application Publication
(10) Pub. No.: US 2020/0170338 A1
(43) Pub. Date: Jun. 4, 2020

(54) THREE LAYER SHOE CONSTRUCTION WITH IMPROVED CUSHIONING, FLEXIBILITY, AND SHOCK ABSORPTION

(71) Applicant: Footwear Unlimited Inc., Fenton, MO (US)

(72) Inventor: Fabio Lucca, Valley Park, MO (US)

(21) Appl. No.: 16/205,459

(22) Filed: Nov. 30, 2018

(51) Int. Cl. A43B 13/12; A43B 13/04; A43B 7/14; A43B 17/14; A43B 7/00; A43B 1/00; A43B 7/32; A43B 13/16; B32B 3/26; B32B 3/30

(52) U.S. Cl. CPC A43B 13/125; A43B 13/122; A43B 13/04; A43B 7/142; A43B 7/143; A43B 17/14; B32B 2437/02; A43B 1/0045; A43B 7/32; A43B 13/16; B32B 3/266; B32B 3/30; A43B 7/00

(57) ABSTRACT

A three-layered shoe construction having a mating relationship between an outsole, an midsole, and an insole. The outsole having a shoulder portion and a plurality of non-linear grooves, the grooves creating flow channels to guide liquid off the outer surface of the outsole and providing additional flexibility; the dual density midsole having an angled portion and a first density in the forefoot area and a second density in the hind foot area, the second density being greater than the first density, the angled portion of the midsole mating with the shoulder portion of the outsole; and the insole having a plurality of curved grooves that cover the top face. The specific construction associated with the outsole, midsole and insole enhance traction, flexibility, cushioning, comfort, breathability and water displacement.

### FIELD OF THE INVENTION

The present invention relates to a shoe construction and, more particularly, to a three layered shoe construction with an outsole having a unique exterior face pattern to provide water displacement and enhanced flexibility and comfort, a dual density midsole, and an insole having a wave design for increased breathability, air circulation, and comfort coupled with a raised arch area for providing additional support to the arch of the foot.

### BACKGROUND OF THE INVENTION

Numerous shoes, covering a broad range of different designs and styles have been manufactured and sold in the marketplace. While shoes are worn to provide protection to one's feet, to reduce the impact felt when walking on hard surfaces, to provide support for the feet, and to prevent pronation, shoe designers must still seek to provide optimum levels of stability and comfort. In order to accomplish all of these objectives, shoe designers have used a wide variety of different tools and methods including heel plugs, shanks, contoured soles, deformable pillars or columns, spring-like structures, different traction designs, cushioning members, different shank designs, different ventilation structures, rocker elements, pads, gels and sole constructions having a plurality of different layers. Although these methods can be effective, the large number of components can result in increased manufacturing costs and complexity. It is therefore desirable to improve cushioning, flexibility, support and stability without increasing the number of components to achieve the same level of comfort for the user.

### SUMMARY OF THE INVENTION

The present invention is directed to a three layer shoe construction which includes an outsole, midsole, and insole. The three layers have a mating relationship which will be later described in detail. The three components of the present shoe are preferably secured together through conventional means such as through cementing and/or adhesives thereby preventing relative movement between the layers during assembly and use of the present shoe. Each of the three layers of the present shoe are generally in the shape of a human foot and can be divided into different sections according to the three different regions of the human foot—the forefoot, the midfoot, and the hind foot. The forefoot is generally adjacent to and includes the toe area; the hind foot is generally adjacent to and includes the heel area; and the midfoot is located adjacent to both the forefoot and the hind foot. The ball of the foot is generally the area of the foot at the juncture between the metatarsal bones and the phalange bones. The two primary regions of the foot for load bearing when walking or standing normally are the ball area and the heel area, and the major bending of the shoe during normal use is typically in the ball area. The arch or instep is positioned between the heel and ball areas and flexes very little when walking normally.

The present outsole is made out of a super lightweight thermoplastic rubber (TPR) and includes an exterior and interior face. The exterior face of the present outsole engages the ground or other walking surfaces, while the interior face is located opposite the exterior face and has a mating relationship with the midsole as will be hereinafter further described in more detail.

The exterior face of the outsole includes a plurality of non-linear grooves to provide a non-slid surface as well as extra flexibility, comfort and water displacement. The heel area of the outsole includes a shoulder portion where a portion of the outsole curves upwards towards the midsole. The interior face of the outsole is substantially smooth.

The midsole is made of a dual density blown ethylene-vinyl acetate copolymer (EVA) with an intrinsic molded raised arch support area which supports the arch of the foot. The EVA creates a lightweight and resilient midsole, which helps dissipate shock when walking or running. In addition to the material itself, the dual density of the midsole allows for a greater flexibility and cushioning in the forefoot area due to its lighter density, and provides greater support and stability in the hind foot area due to its heavier density. The sidewall of the midsole includes a first and a second sidewall section, both of which extend completely around the perimeter of the midsole and both of which are preferably smooth. Like the outsole, the hind foot area of the midsole includes an angled portion which curves upwards away from the outsole.

The midsole includes a proximal and a distal face. The distal face of the midsole includes a plurality of grooves located and positioned in the forefoot area which provide additional flexibility at the ball area of the foot, allowing the midsole to flex more easily when the wearer walks. The distal face of the midsole further includes a plurality of apertures extending in spaced apart relationship across the distal face further increasing the flexibility of the midsole overall as well as reducing its overall weight. The midsole has a mating relationship with the outsole, where the angled portion of the midsole aligns and mates with the shoulder portion of the outsole. The mating of the angled portion of the midsole with the shoulder portion of the outsole reduces the impact felt when walking or running and further propels the weight of the wearer forward in a rolling motion from the heel area to the ball area of the foot.

The proximal face of the midsole includes a ledge or flange that extends around the entire circumference of the midsole thereby creating a first cavity substantially in the shape of the midsole. The insole mates with and is received by the first cavity created by the ledge on the proximal face of the midsole. The proximal face of the midsole further includes a ridge located on the upper surface of the ledge, the ridge extending around the entire circumference of the midsole creating a second cavity in the midsole between the insole and the ridge as will be further explained. The three layers are preferably secured together to prevent movement when worn.

The insole is a lightweight, thermal molded EVA with an antimicrobial shield which provides protection against bacteria, fungus, and controls or eliminates odors, stains, and product deterioration. This can be accomplished by adding a powder or other antimicrobial agents during the manufacturing process. The insole has a top face and a bottom face, the top face engaging with the foot of a wearer and includes a plurality of wavy grooves that provide both greater flexibility and breathability when the overall shoe is worn.

The present three layer shoe construction absorbs shock, enhances comfort, and creates a unique propulsion effect, without requiring a vast number of components.

### BRIEF DESCRIPTION OF THE DRAWINGS

For a better understanding of the various embodiments of the present invention, reference may be made to the accompanying drawings in which:

FIG. 1 is an exploded perspective view illustrating a shoe structure constructed according to the teachings of the present invention;

FIG. 2 is a side elevational view of the outsole of FIG. 1;

FIG. 3 is a bottom plan view of the outsole of FIGS. 1 and 2;

FIG. 4. is a top plan view of the outsole of FIGS. 1, 2, and 3;

FIG. 5 is a side elevational view of a midsole of FIG. 1;

FIG. 6 is a bottom plan view of the midsole of FIGS. 1 and 5;

FIG. 7 is a bottom plan view of the outsole and midsole of FIGS. 1-6 mated together;

FIG. 8 is a side elevational view of the outsole and midsole of FIG. 7;

FIG. 9 is a top plan view of the midsole of FIGS. 1 and 5-8;

FIG. 10 is a top plan view of the midsole and an insole of FIG. 1 mated together;

FIG. 11 is a side elevational view of the insole of FIGS. 1 and 10;

FIG. 12 is a top plan view of the insole of FIGS. 1, 10, and 11; and

FIG. 13 is a bottom plan view of the insole of FIGS. 1 and 10-12.

While the disclosure is susceptible to various modifications and alternative forms, specific embodiments thereof are shown by way of example in the drawings and will hereafter be described in detail. It should be understood, however, that the drawings and detailed description presented herein are not intended to limit the disclosure of the present invention to the particular embodiment disclosed, but on the contrary, the intention is to cover all modifications, equivalents, and alternatives falling within the spirit and scope of the present disclosure.

### DETAILED DESCRIPTION OF THE DRAWINGS

The present invention will now be described with reference to the drawing figures in which like reference numerals refer to like parts throughout the disclosure. For purposes of clarity in illustrating the characteristics of the present invention, proportional relationships of the elements have not necessarily been maintained in the drawing figures.

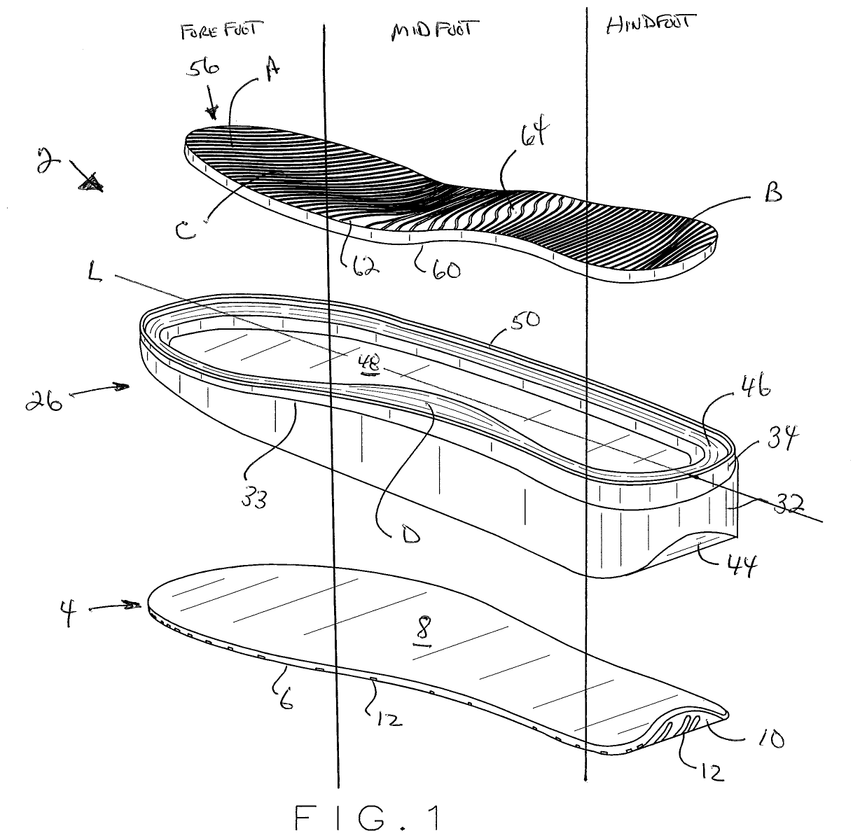

As illustrated in FIG. 1, a three layer shoe construction 2 constructed in accordance with the teachings of the present invention includes an outsole 4, a midsole 26, and an insole 56. The outsole 4, midsole 26, and insole 56 have a mating relationship to each other as will be hereinafter further described. The combination of the three layers produces flexibility and shock absorption, as well as a unique cushioning and bouncing propulsion effect allowing the wearer to walk more easily. The layers of the present shoe are preferably secured together in a conventional manner such as through cementing and/or adhesives thereby preventing relative movement between the layers during assembly and use of the present shoe.

Each of the three layers of the present shoe are generally in the shape of a human foot and can be divided into different sections according to three distinct regions of the human foot—the forefoot, midfoot, and hind foot. The forefoot area or region of the foot is approximately adjacent to and includes the toe area A, while the hind foot area or region of the foot is approximately adjacent to and includes the heel area B. The midfoot area or region is approximately adjacent to both the forefoot and hind foot regions as illustrated in FIG. 1 and includes the arch area D. The ball area C of the foot is generally the area of the foot at the juncture between the metatarsal bones and the phalange bones. The two primary regions of the foot for load bearing when walking or standing normally includes the ball area C and the heel area B, and the major bending of the shoe during normal use is typically in the vicinity of the ball area C. The arch or instep area D is located between the heel area B and ball area C, and flexes very little when walking normally. The three layers of the present shoe also include a longitudinal axis L, which extends through the forefoot, midfoot and hind foot, and can further be divided into a medial and lateral half. The medial half is located on the side of the longitudinal axis that includes the arch area D, while the lateral half is located on the other side of the longitudinal axis.

The present outsole 4 is made out of a super lightweight thermoplastic rubber (TPR) and includes an exterior face 6 and an interior face 8 as seen in FIG. 2. The exterior face 6 of the outsole 4 engages with the ground or other walking surfaces, while the interior face 8 has a mating relationship with the midsole 26 as will be hereinafter described in more detail. The outsole 4 further includes an upwardly extending shoulder portion 10 located and positioned at the heel area B. The shoulder portion 10 of the outsole 4 slopes upwards at a gradual angle, away from the ground or other supporting surface and towards the midsole 26. In other words, when the outsole 4 is placed with the exterior face 6 engaging the ground or other supporting surface, the shoulder portion 10 does not engage or touch the ground or other surface. The remainder of the outsole 4 is preferably substantially planar and does not curve or slope. Although in other embodiments, the toe area A may also slope upwards.

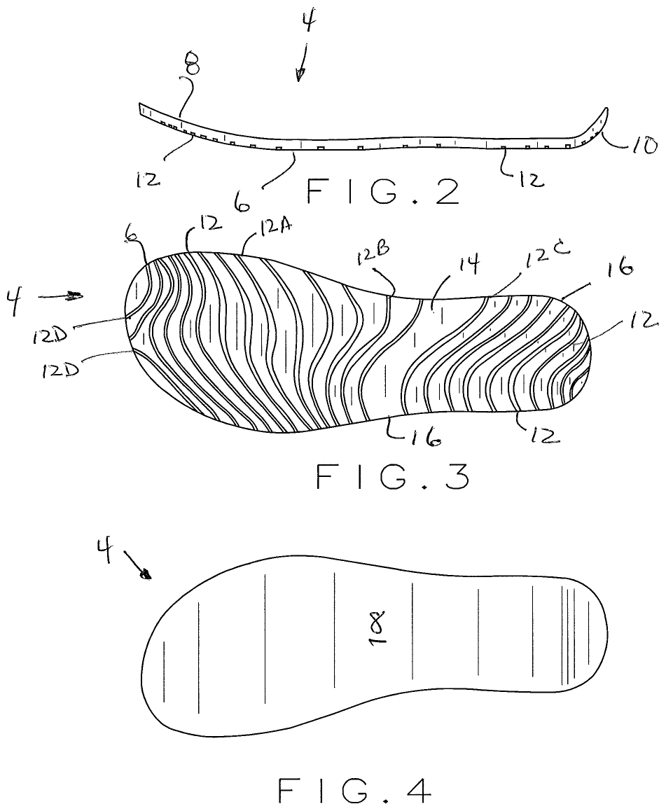

In one embodiment, the exterior face 6 of the outsole 4 includes a plurality of non-linear grooves 12 as best illustrated in FIGS. 3 and 7. In one embodiment, the majority of the plurality of non-linear grooves 12 are located and positioned in spaced apart relationship to each other and extend from the medial side to the lateral side of the outsole 4. At least one of the non-linear grooves 12 such as groove 12A extends diagonally from the midfoot area at the lateral side towards the forefoot area of the medial side, while at least one other non-linear groove 12 such as groove 12B extends substantially horizontally across the midfoot area, and still yet at least one other non-linear groove 12 such as groove 12C extends diagonally from the midfoot area of the lateral side to the medial side of the hind foot area. In the toe area of the outsole 4, some of the non-linear grooves 12 such as grooves 12D begin by extending from the toe area before curving towards either the medial side or the lateral side of the outsole 4. Both the number and spacing of the non-linear grooves 12 may vary as each groove of the pattern extends somewhat horizontally across the outsole. The non-linear grooves 12 create a fluid flow channel that guides liquid off the outer surface 14 to the outer perimeter 16 of the outsole 4, thereby preventing the outer surface 14 from being slippery. The non-linear grooves 12 also increase flexibility and comfort, allowing the wearer to flex the outsole 4 more easily when the shoe is worn. The interior face 8 of the outsole 4 is substantially smooth as seen in FIG. 4.

The midsole 26 is made of a dual density blown ethylene-vinyl acetate copolymer (EVA) with an intrinsic molded raised arch support area 28 which supports the arch area D of the foot, reinforcing the arch in its proper position, which is best shown in FIG. 9. The EVA creates a lightweight and resilient midsole 26 which helps dissipate shock when walking or running. In addition to the material itself, the dual density of the midsole 26 allows for a greater flexibility and cushioning in the forefoot area due to its lighter density, and provides greater support and stability in the hind foot area due to its heavier density. In simple terms, the forefoot area C of the present midsole 26 has a lighter density as compared to a heavier density heel area B.

The sidewall 30 of the midsole 26 includes a first sidewall section 32 and a second sidewall section 34, where both the first sidewall section 32 and the second sidewall section 34 extend completely around the perimeter of the midsole 26 as best illustrated in FIG. 5. The first sidewall section 32 and the second sidewall section 34 are substantially smooth and form a ledge 33 at their joinder. The first sidewall section 32 is located and positioned adjacent to and abuts the outsole 4, while the second sidewall section 34 is located and positioned above the first sidewall section 32, closer to the insole 56. The first sidewall section 32 is formed substantially in the shape of the outsole 4, and extends substantially perpendicular from the exterior face 6 of the outsole 4, with the exception of the angled portion 44 which will be explained in greater detail hereinafter. The second sidewall section 34, on the other hand, tapers slightly outwards as it extends away from the first sidewall section 32. The combination of the first sidewall section 32 and second sidewall section 34 increases the amount of cushioning and absorbs shock when the wearer is walking or running.

The midsole 26 further includes both a proximal face 36 and a distal face 38, the proximal face 36 having a mating relationship with the insole 56 and the distal face 38 having a mating relationship with the outsole 4. The distal face 38 further includes an angled portion 44 located and positioned at the heel area B. The angled portion 44 gradually slopes upwards from the distal face 38 towards the proximal face 36 so that the sidewall 32 forms or slopes at an angle to the distal face 38. The sidewall 34 preferably abuts the proximal face 36 at a substantially perpendicular angle. In alternative embodiments, the intersection of the sidewall 30 and distal face 38 (or the intersection of the sidewall 30 and the proximal face 36) may be at different angles.

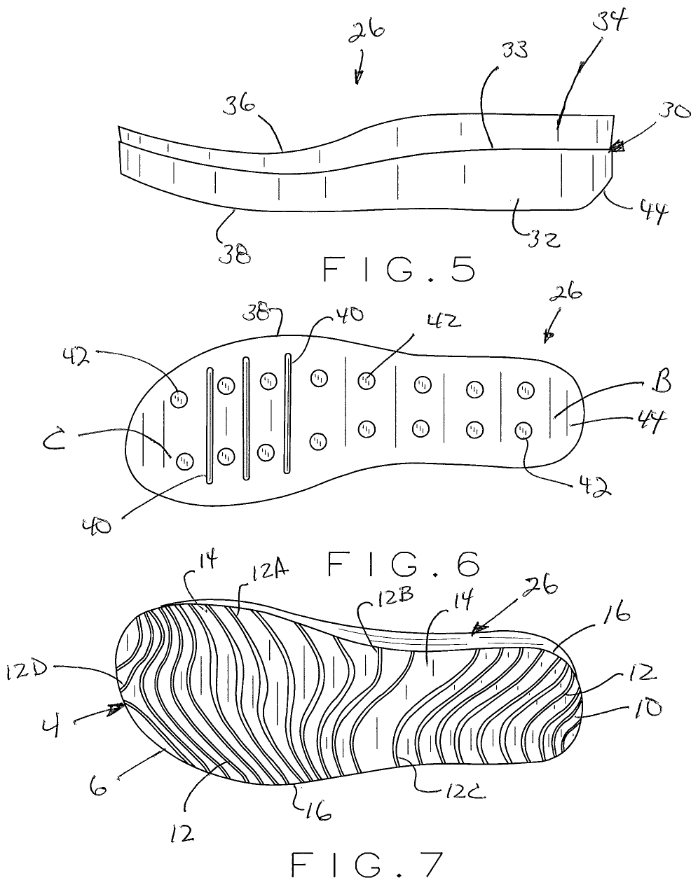

Referring to FIG. 6, the distal face 38 of midsole 26 includes a plurality of grooves 40 that extend substantially horizontally across the forefoot area, from the medial side to the lateral side of the midsole 26. The plurality of grooves 40 provides additional flexibility at the ball area C of the foot, allowing the midsole 26 to more easily flex when the wearer walks. The distal face 38 of the midsole 26 may further include a plurality of apertures 42 to reduce the weight and increase flexibility of the midsole 26 thereby increasing comfort when the present shoe is worn. The plurality of apertures 42 may be circular, but other shapes are envisioned and foreseeable. The plurality of apertures 42 may be located and positioned in a set of two rows that extend substantially side by side along the longitudinal axis L and along substantially the entire length of the distal face 38 of midsole 26. The plurality of apertures 42 in the two rows may be substantially the same in both number and spacing. However, in other embodiments, the number and spacing of the plurality of apertures 42 may vary. In one embodiment, the midsole 26 may have sixteen apertures 42. The plurality of apertures 42 may also take on a variety of other patterns and spacings without departing from the spirit and scope of the present invention.

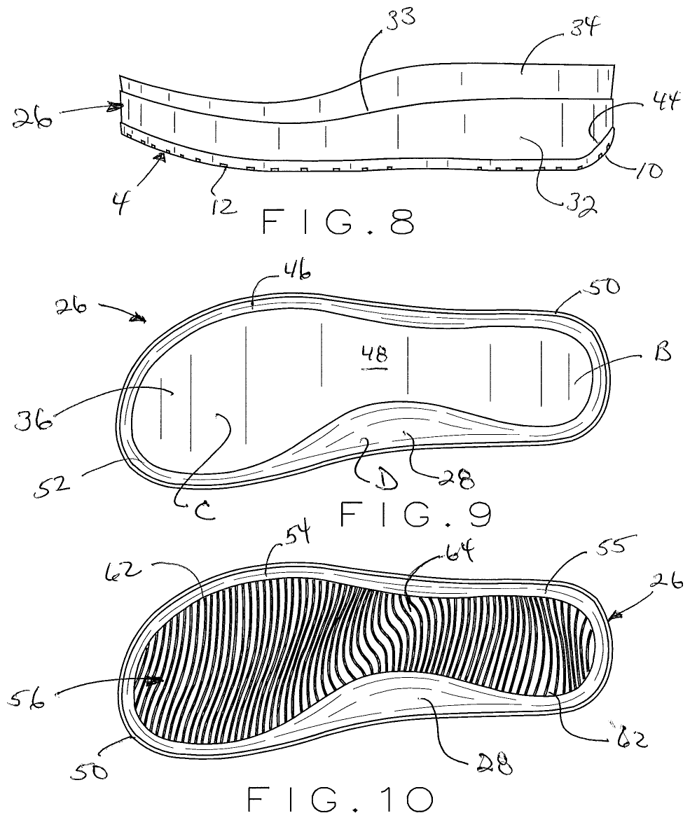

The midsole 26 is substantially in the shape of the outsole 4 and has a mating relationship with the outsole 4. The angled portion 44 of the midsole 26 aligns and mates with the shoulder portion 10 of the outsole 4. Thus, the shoulder portion 10, the shoulder portion 10 substantially cups and surrounds the angled portion 44 as best illustrated in FIGS. 7 and 8. The combination of the shoulder portion 10 of the outsole 4 and the angled portion 44 of the midsole 26 provides shock absorption and reduces the impact felt when walking and further propels the weight of the wearer forward in a rolling motion from the heel area B to the ball area C of the foot.

The insole 56 also has a mating relationship to the midsole 26. The proximal face 36 of the midsole 26 has a ledge or flange 46 extending around its entire circumference creating a cavity 48 substantially in the shape of the insole 56 as shown in FIG. 9. The insole 56 mates with and is received by the cavity 48 created by the ledge 46 on the proximal face 36 of the midsole 26 as illustrated in FIG. 10. In some embodiments, the proximal face 36 further includes a ridge or flange 50 located and positioned on the upper surface 52 of the ledge 46 as shown in FIGS. 9 and 10, the flange 50 extending above and entirely around the periphery of the ledge 46. The ridge 50 extends upwards from the ledge 46 and forms part of the midsole sidewall 34. The ridge 50 and ledge 46 form a perimeter channel 55 around the perimeter of the midsole. When the insole 56 is received within the midsole cavity 48, the perimeter of the insole 56 lies slightly above the top surface 52 of the ledge 46 thereby forming a second cavity 54 in the midsole, or a valley in between the ridge 50 and the perimeter of the insole 56, as best shown in FIG. 7. The bottom surface of the cavity 54 is the upper surface 52 of the ledge 46. Cloth, leather, or other upper materials may be placed within the cavity or valley 54, or the perimeter channel 55 adjacent the insole 56 for decorative purposes. The three layers are preferably secured together by cementing and/or adhesives thereby preventing relative movement between the layers during assembly and use of the present shoe.

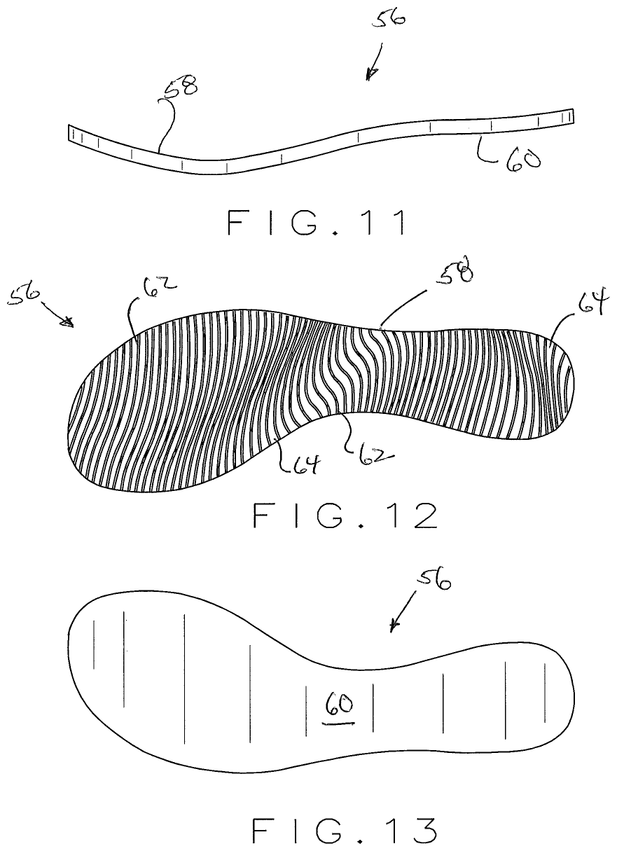

The insole 56 is a lightweight, thermal molded EVA with an antimicrobial shield which provides protection against bacteria, fungus, and controls or eliminates odors, stains, and product deterioration. This can be accomplished by adding a powder or other antimicrobial agents during the manufacturing process. The insole 56 has a top face 58 and a bottom face 60 as best illustrated in FIG. 11. Turning to FIG. 12, the top face 58 engages with the foot of a wearer and has a scored pattern which includes a plurality of curved grooves 62 that provides both greater flexibility and breathability when worn. The plurality of curved or non-linear grooves 62 covers the entire top face 58 forming a plurality of non-linear raised projections 64. In one embodiment, the plurality of curved grooves 62 extend across the insole 56 in a spaced apart relationship from the medial side to the lateral side, and cover the top face 58 of the insole 56. The plurality of curved grooves 62 may be substantially straight extending from the medial side to the lateral side in the forefoot and hind foot areas. The plurality of curved or non-linear grooves 62 in the midfoot area, however, may have at least one curve or bend in their length when extending from the medial side to the lateral side. The bottom face 60 is substantially smooth and is received by the cavity 48 of the midsole 26 as best illustrated in FIG. 13. The combination of the outsole 4, midsole 26, and insole 56 allows for great shock absorption, cushioning, flexibility and also produces a unique bouncing propulsion effect. The grooves 12 on the exterior face 6 of the outsole also provide for improved water displacement.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A shoe construction comprising:
an outsole having an outer perimeter, an exterior face, an interior face, a medial side, a lateral side, and a shoulder portion, the exterior face including a plurality of non-linear grooves which extend across the outsole from the outer perimeter on the medial side to the outer perimeter on the lateral side;
a midsole having a proximal face, a distal face, a medial side, a lateral side, an outer perimeter, a forefoot area, a midfoot area, a hind foot area, and an angled portion, the midsole having a first density in the forefoot area and a second density in the hind foot area, the distal face of the midsole having a plurality of apertures in the forefoot area, midfoot area, and hind foot area, the distal face of the midsole further having a plurality of grooves in the forefoot area extending from the lateral side towards the medial side, the midsole having a first cavity located and positioned on its proximal face; and
an insole having a top face and a bottom face, the top face of the insole including a plurality of curved grooves;
the distal face of the midsole being shaped and dimensioned to mate with the outsole, the angled portion of the midsole being shaped and dimensioned to mate with the shoulder portion of the outsole, and the first cavity on the proximal face of the midsole being shaped and dimensioned to receive the insole.

2. The shoe construction of claim 1 wherein the midsole includes a ridge forming a second cavity located between a perimeter of the insole and the ridge when the insole is received within the first cavity.

3. The shoe construction of claim 1 wherein the outsole is made of a super lightweight thermoplastic rubber.

4. The shoe construction of claim 1 wherein the midsole is made of an ethylene-vinyl acetate copolymer.

5. The shoe construction of claim 1 wherein the midsole includes a sidewall extending completely around the perimeter of the midsole, the sidewall being substantially smooth.

6. The shoe construction of claim 1 wherein the midsole includes a sidewall extending completely around the perimeter of the midsole, the sidewall having a first sidewall portion and a second sidewall portion.

7. The shoe construction of claim 1 wherein the midsole includes an arch support.

8. The shoe construction of claim 1 wherein the insole is made of a lightweight thermal molded EVA.

9. A shoe construction comprising:
an outsole having an outer perimeter, an exterior face, an interior face, a medial side, a lateral side, and an upwardly extending shoulder portion, the exterior face including a plurality of non-linear grooves which extend across the outsole from the outer perimeter on the medial side to the outer perimeter on the lateral side;
a midsole having a proximal face, a distal face, a medial side, a lateral side, an outer perimeter, a forefoot area, a midfoot area, a hind foot area, and an angled portion associated with the hind foot area, the midsole having a first density in the forefoot area and a second density in the hind foot area, the midsole having an arch support, the distal face of the midsole having a plurality of apertures in the forefoot area, midfoot area, and hind foot area, the distal face of the midsole further having a plurality of grooves in the forefoot area which extend from the lateral side towards the medial side, the midsole having a first cavity located and positioned on its proximal face; and
an insole having a top face and a bottom face, the top face of the insole including a plurality of non-linear grooves;
the distal face of the midsole being shaped and dimensioned to mate with the outsole, the angled portion of the midsole being shaped and dimensioned to mate with the shoulder portion of the outsole, and the first cavity on the proximal face of the midsole being shaped and dimensioned to receive the insole.

10. The shoe construction of claim 9 wherein the outsole is made of a super lightweight thermoplastic rubber.

11. The shoe construction of claim 9 wherein the midsole is made of an ethylene-vinyl acetate copolymer.

12. The shoe construction of claim 9 wherein the insole is made of a lightweight thermal molded EVA.

13. The shoe construction of claim 9 wherein the midsole includes a sidewall extending completely around the perimeter of the midsole, the sidewall being substantially smooth.

14. The shoe construction of claim 9 wherein the midsole includes a sidewall extending completely around the perimeter of the midsole, the sidewall having a first sidewall section, a second sidewall section, and a ledge formed therebetween.

15. A shoe construction comprising:
an outsole having an outer perimeter, an exterior face, an interior face, a medial side, a lateral side, a forefoot area, a midfoot area, a hind foot area, and a shoulder portion extending upwardly from the hind foot area, the exterior face including a plurality of non-linear grooves which extend across the outsole from the outer perimeter on the medial side to the outer perimeter on the lateral side;
a midsole having a proximal face, a distal face, a medial side, a lateral side, an outer perimeter, a forefoot area, a midfoot area, a hind foot area, and an angled portion extending upwardly from the distal face in the hind foot area, the midsole having a first density in the forefoot area and a second density in the hind foot area, the midsole including a sidewall extending completely around the perimeter of the midsole, the sidewall of the midsole having a first sidewall section and a second sidewall section, the first sidewall and the second sidewall being substantially smooth, one of said first and second sidewall sections forming a ridge around the outer perimeter of the midsole, the midsole further having an arch support, the distal face of the midsole having a plurality of apertures in the forefoot area, midfoot area, and hind foot area, the distal face of the midsole further having a plurality of grooves in the forefoot area which extend from the lateral side towards the medial side, the midsole having a first cavity located and positioned on its proximal face; and
an insole having a top face and a bottom face, the top face of the insole including a plurality of curved grooves;
the distal face of the midsole being shaped and dimensioned to mate with the outsole, the angled portion of the midsole being shaped and dimensioned to mate with the shoulder portion of the outsole, and the first cavity on the proximal face of the midsole being shaped and dimensioned to receive the insole, the perimeter of the insole and said ridge forming a second cavity on the proximal face of the midsole.

16. The shoe construction of claim 15 wherein the plurality of curved grooves on the top face of the insole extend from the medial side to the lateral side of the outsole.

17. The shoe construction of claim 15 wherein the insole includes an antimicrobial shield.
